(19) United States
(12) Patent Application Publication
(10) Pub. No.: US 2025/0271049 A1
(43) Pub. Date: Aug. 28, 2025

(54) BIDIRECTIONAL TO UNIDIRECTIONAL GEARSET

(71) Applicant: Hamilton Sundstrand Corporation, Charlotte, NC (US)

(72) Inventor: Aaron M. Finke, Janesville, WI (US)

(21) Appl. No.: 18/588,903

(22) Filed: Feb. 27, 2024

(51) Int. Cl. F16H 1/00; F16H 1/20; F16H 1/22; H02K 7/116; H02K 9/193

(52) U.S. Cl. CPC F16H 1/003; F16H 1/206; F16H 1/22; H02K 7/116; H02K 9/193

(57) ABSTRACT

An apparatus includes a gearset that includes an input gear configured to be rotated by an input shaft, first and second one-way clutches, first and second output gears configured to drive rotation of an output shaft via the first and second one-way clutches, respectively, and an idler gear. The second output gear has a smaller outer diameter than the first output gear. The input gear is configured to (i) rotate the first output gear in a first direction and (ii) rotate the idler gear in the first direction. The idler gear is configured to rotate the second output gear in a second direction opposite the first direction. The first and second one-way clutches are configured to allow the first and second output gears to drive rotation of the output shaft in a single predetermined rotational direction regardless of a rotational direction of the input shaft.

### TECHNICAL FIELD

This disclosure is generally directed to gearboxes and related systems and processes. More specifically, this disclosure is directed to a bidirectional to unidirectional gearset.

### BACKGROUND

Turbomachines and other mechanical devices often include rotating input shafts that are used to drive rotating output shafts. The conversion of input rotation from an input shaft into output rotation of an output shaft is typically accomplished using a set of gears, which is referred to as a gearset.

### SUMMARY

This disclosure is directed to a bidirectional to unidirectional gearset.

In a first embodiment, a system includes a rotatable shaft having a first end and an opposing second end, a first mechanical device configured to receive a first rotational input from the first end of the rotatable shaft, and a second mechanical device configured to receive a second rotational input from the second end of the rotatable shaft. The second rotational input is opposite the first rotational input. Each of the first and second mechanical devices includes a gearset that includes an input gear configured to be rotated by the rotatable shaft, first and second one-way clutches, first and second output gears configured to drive rotation of an output shaft via the first and second one-way clutches, respectively, and an idler gear. The input gear of the first gearset is configured to (i) rotate the first output gear of the first gearset in a first direction and (ii) rotate the idler gear of the first gearset in the first direction, and the idler gear of the first gearset is configured to rotate the second output gear of the first gearset in a second direction opposite the first direction. The input gear of the second gearset is configured to (i) rotate the first output gear of the second gearset in the second direction and (ii) rotate the idler gear of the second gearset in the second direction, and the idler gear of the second gearset is configured to rotate the first output gear of the second gearset in the first direction. The first and second one-way clutches of each gearset are configured to allow the first and second output gears of the gearset to drive rotation of the associated output shaft in a single predetermined rotational direction regardless of a rotational direction of the rotatable shaft relative to the gearset.

In a second embodiment, an apparatus includes a gearset that includes an input gear configured to be rotated by an input shaft, first and second one-way clutches, first and second output gears configured to drive rotation of an output shaft via the first and second one-way clutches, respectively, and an idler gear. The second output gear has a smaller outer diameter than the first output gear. The input gear is configured to (i) rotate the first output gear in a first direction and (ii) rotate the idler gear in the first direction. The idler gear is configured to rotate the second output gear in a second direction opposite the first direction. The first and second one-way clutches are configured to allow the first and second output gears to drive rotation of the output shaft in a single predetermined rotational direction regardless of a rotational direction of the input shaft.

In a third embodiment, a method includes imparting rotational input to an input gear of a gearset using an input shaft. The method also includes driving rotation of an output shaft using first and second output gears of the gearset respectively via first and second one-way clutches and an idler gear of the gearset. The input gear (i) rotates the first output gear in a first direction and (ii) rotates the idler gear in the first direction. The idler gear rotates the second output gear in a second direction opposite the first direction. The first and second one-way clutches allow the first and second output gears to drive rotation of the output shaft in a single predetermined rotational direction regardless of a rotational direction of the input shaft. The second output gear has a smaller outer diameter than the first output gear.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIGS. 1 and 2 illustrate an example bidirectional to unidirectional gearset according to this disclosure;

FIGS. 3 and 4 illustrate example operations of a bidirectional to unidirectional gearset according to this disclosure; and

FIGS. 5 through 7 illustrate an example system that incorporates multiple bidirectional to unidirectional gearsets according to this disclosure.

### DETAILED DESCRIPTION

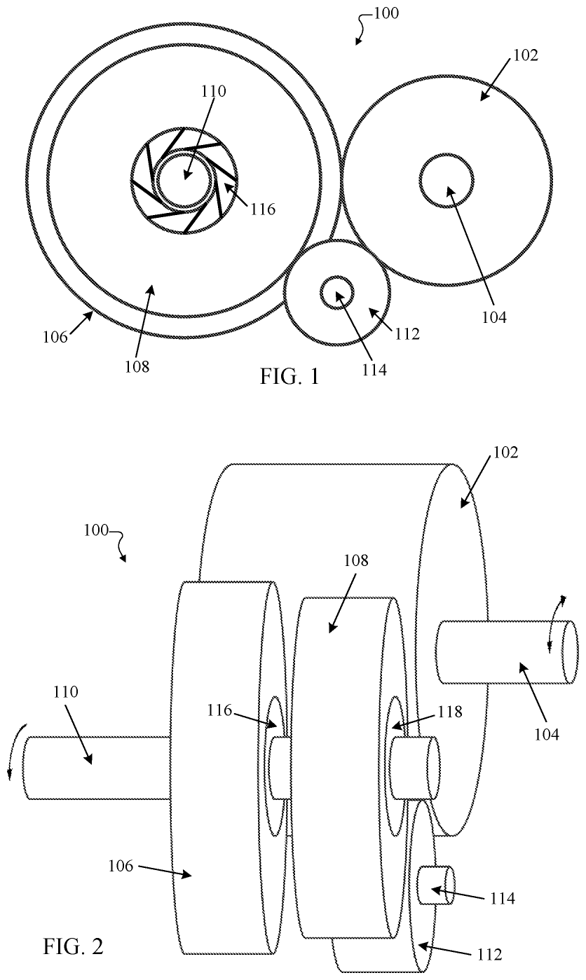

FIGS. 1 through 7, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As described above, turbomachines and other mechanical devices often include rotating input shafts that are used to drive rotating output shafts. The conversion of input rotation from an input shaft into output rotation of an output shaft is typically accomplished using a set of gears, which is referred to as a gearset. Unfortunately, turbomachines and other mechanical devices are generally designed to receive input rotation in a specific direction, which is typically expressed as either clockwise (CW) rotation or counterclockwise (CCW) rotation. In some situations, due to space constraints or other constraints, it is not possible to provide a desired direction of rotation to a turbomachine or other mechanical device. In other situations, there may be a desire to use multiple turbomachines or other mechanical devices, but the direction of rotation may be reversed at the locations of the turbomachines or other mechanical devices. One approach to solving the latter issue may be to design different versions of the turbomachines or other mechanical devices that accept input rotations in different directions, but this can lead to inefficiencies in design and manufacture, lead to installation mistakes, and require personnel to maintain different devices in stock for use.

This disclosure provides bidirectional to unidirectional gearsets that have the ability to convert bidirectional input rotation into unidirectional output rotation. In other words, a bidirectional to unidirectional gearset generates output rotation in the same direction (one of clockwise or counterclockwise) regardless of whether the input rotation is clockwise or counterclockwise. As described in more detail below, the gearset includes an input gear, first and second output gears, and an idler gear. The input gear can be coupled to an input shaft, and the first and second output gears can both be coupled to an output shaft. The input gear is configured to simultaneously drive the first output gear and the idler gear, and the idler gear is configured to drive the second output gear. One-way clutches are positioned between the first and second output gears and the output shaft, and the one-way clutches allow the first or second output gear to drive rotation of the output shaft in the same direction. During operation, the first output gear may be used to drive the output shaft when the input shaft is rotating in one direction, and the second output gear may be used to drive the output shaft when the input shaft is rotating in the opposite direction. In this way, the output shaft rotates in the same direction regardless of the direction of the input rotation.

This disclosure also provides systems that can use multiple instances of such a bidirectional to unidirectional gearset. For example, a system may include multiple mechanical devices, such as multiple turbomachines like electric generators with integral or coupled oil pumps. The multiple mechanical devices can be coupled to opposite ends of a rotating input shaft. As a result, the mechanical devices can receive input rotation in different directions, such as when one mechanical device at one end of the rotating input shaft receives clockwise input rotation and another mechanical device at the opposite end of the rotating input shaft receives counterclockwise input rotation. Each mechanical device can include an instance of the bidirectional to unidirectional gearset, which allows each mechanical device to convert its respective input rotation into a suitable output rotation for use by the mechanical device or other device. In this way, a common design can be used for the mechanical devices, rather than separate designs for mechanical devices used at different locations.

FIGS. 1 and 2 illustrate an example bidirectional to unidirectional gearset 100 according to this disclosure. As shown in FIGS. 1 and 2, the gearset 100 includes an input gear 102, which can be coupled to and rotate with an input shaft 104. The input shaft 104 represents a structure that can provide input rotation to the gearset 100. As shown here, the input shaft 104 may rotate clockwise and/or counterclockwise. The exact rotation direction of the input shaft 104 can vary depending on the application. In some embodiments, for example, the input shaft 104 may rotate in only one direction (either clockwise or counterclockwise), such as when the input shaft 104 is designed or is coupled to another component that is designed to rotate in only one direction. In other embodiments, the rotation direction of the input shaft 104 may vary over time.

The gearset 100 also includes a first output gear 106 and a second output gear 108, each of which can be coupled to and rotate about an output shaft 110. The output shaft 110 represents a structure that can provide output rotation from the gearset 100, such as to an external component that is designed to receive rotation in a specific direction. As shown here, the output shaft 110 may rotate in only one direction, either clockwise or counterclockwise. Again, the exact rotation direction of the output shaft 110 can vary depending on the application. The gearset 100 further includes an idler gear 112, which can be connected to and rotate with an idler shaft 114. The idler shaft 114 represents a structure that can allow the idler gear 112 to rotate freely in either direction.

The output gears 106 and 108 are respectively connected to the output shaft 110 using one-way clutches 116 and 118. Each one-way clutch 116 and 118 represents a structure that allows the associated output gear 106 and 108 to drive rotation of the output shaft 110 in one direction and prevent rotation of the output shaft 110 in the opposite direction. In other words, the one-way clutches 116 and 118 are configured to engage and allow the output shaft 110 to be respectively driven by the output gears 106 and 108 in one direction and to disengage and prevent the output shaft 110 from being respectively driven by the output gears 106 and 108 in the opposite direction. For example, the one-way clutch 116 may engage and allow the first output gear 106 to drive the output shaft 110 in one direction (such as counterclockwise), in which case the one-way clutch 118 may disengage and allow the second output gear 108 to rotate freely without driving the output shaft 110. Also, the one-way clutch 118 may engage and allow the second output gear 108 to drive the output shaft 110 in the same direction (such as counterclockwise), in which case the one-way clutch 116 may disengage and allow the first output gear 106 to rotate freely without driving the output shaft 110. As described below, this configuration allows for the conversion of the input rotation from the input shaft 104 (regardless of its direction) into a known single-direction output rotation of the output shaft 110. Each one-way clutch 116 and 118 may represent any suitable structure configured to allow selective driving of the output shaft 110 depending on rotation direction, such as a sprag, roller, pawl, or other type of one-way clutch.

Each gear 102, 106, 108, 112 includes any suitable structure having teeth or other elements that can interact with and rotate or be rotated by another gear. Each gear 102, 106, 108, 112 may be formed using any suitable material(s), such as one or more metals. Each gear 102, 106, 108, 112 may also be formed using any suitable technique(s), such as an additive or subtractive manufacturing process. In addition, each gear 102, 106, 108, 112 may have any suitable size, shape, and dimensions.

In some embodiments, such as the one shown in FIGS. 1 and 2, the input gear 102 can have a substantially uniform outer diameter, at least at the portions of the input gear 102 that contact the first output gear 106 and the idler gear 112. Also, in some embodiments, the first and second output gears 106 and 108 can have different outer diameters, such as when the first output gear 106 has a larger outer diameter than the second output gear 108. Among other things, this can allow the idler gear 112 to be positioned partially over the first output gear 106 in the view shown in FIG. 1, which may help to reduce the overall package size of the gearset 100. That is, when the gearset 100 is viewed from a direction parallel to the axes of the input and output shafts 104 and 110, a portion of the idler gear 112 can overlap a portion of the first output gear 106. However, the actual sizes of the gears 102, 106, 108, 112 can vary based on a number of factors.

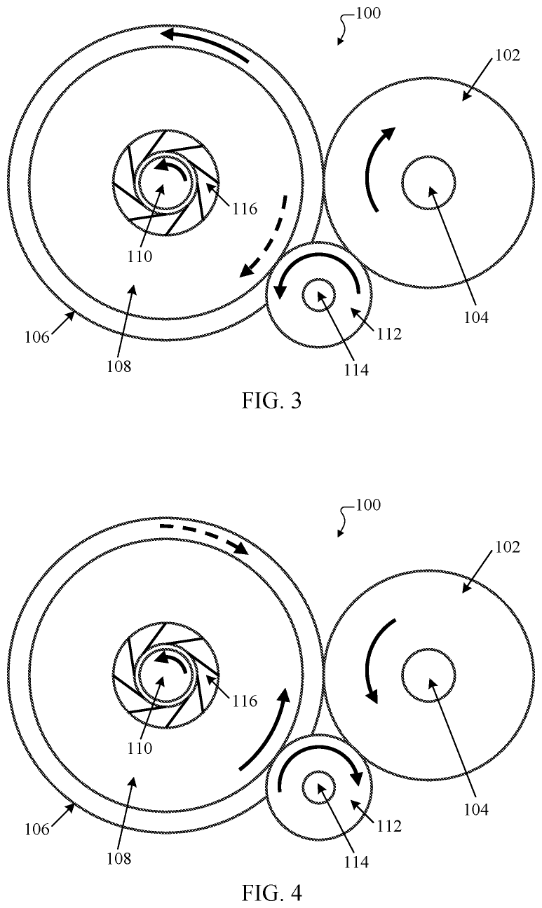

FIGS. 3 and 4 illustrate example operations of the bidirectional to unidirectional gearset 100 according to this disclosure. As shown in FIG. 3, the input shaft 104 is rotating clockwise, which causes the input gear 102 to also rotate clockwise. This clockwise rotation of the input gear 102 causes counterclockwise rotation of the first output gear 106. This clockwise rotation of the input gear 102 also causes counterclockwise rotation of the idler gear 112, which causes the second output gear 108 to rotate clockwise. The opposite rotational directions of the output gears 106 and 108 (which are coupled to the same output shaft 110) are accommodated using the one-way clutches 116 and 118. More specifically, the one-way clutch 116 is engaged and the one-way clutch 118 is disengaged here, which allows the first output gear 106 to rotate the output shaft 110 counterclockwise. The second output gear 108 may continue to rotate clockwise, but the one-way clutch 118 prevents the second output gear 108 from driving rotation of the output shaft 110.

As shown in FIG. 4, the input shaft 104 is rotating counterclockwise, which

causes the input gear 102 to also rotate counterclockwise. This counterclockwise rotation of the input gear 102 causes clockwise rotation of the first output gear 106. This counterclockwise rotation of the input gear 102 also causes clockwise rotation of the idler gear 112, which causes the second output gear 108 to rotate counterclockwise. Again, the opposite rotational directions of the output gears 106 and 108 (which are coupled to the same output shaft 110) are accommodated using the one-way clutches 116 and 118. More specifically, the one-way clutch 118 is engaged and the one-way clutch 116 is disengaged here, which allows the second output gear 108 to rotate the output shaft 110 counterclockwise. The first output gear 106 may continue to rotate clockwise, but the one-way clutch 116 prevents the first output gear 106 from driving rotation of the output shaft 110.

As a result, the output shaft 110 can rotate counterclockwise regardless of the rotational direction of the input shaft 104. Note, however, that the rotational direction of the output shaft 110 may be clockwise using suitable changes to the design of the gearset 100, such as by reversing the directions in which the one-way clutches 116 and 118 engage and disengage.

Although FIGS. 1 and 2 illustrate one example of a bidirectional to unidirectional gearset 100 and FIGS. 3 and 4 illustrate examples of operations of the bidirectional to unidirectional gearset 100, various changes may be made to FIGS. 1 through 4. For example, the sizes of various gears 102, 106, 108, 112 in the gearset 100 can be tuned or adjusted in order to provide desired gear ratios within the gearset 100. Also, the one-way clutches 116 and 118 can be configured to engage and disengage in desired directions in order to impart desired rotation to the output shaft 110.

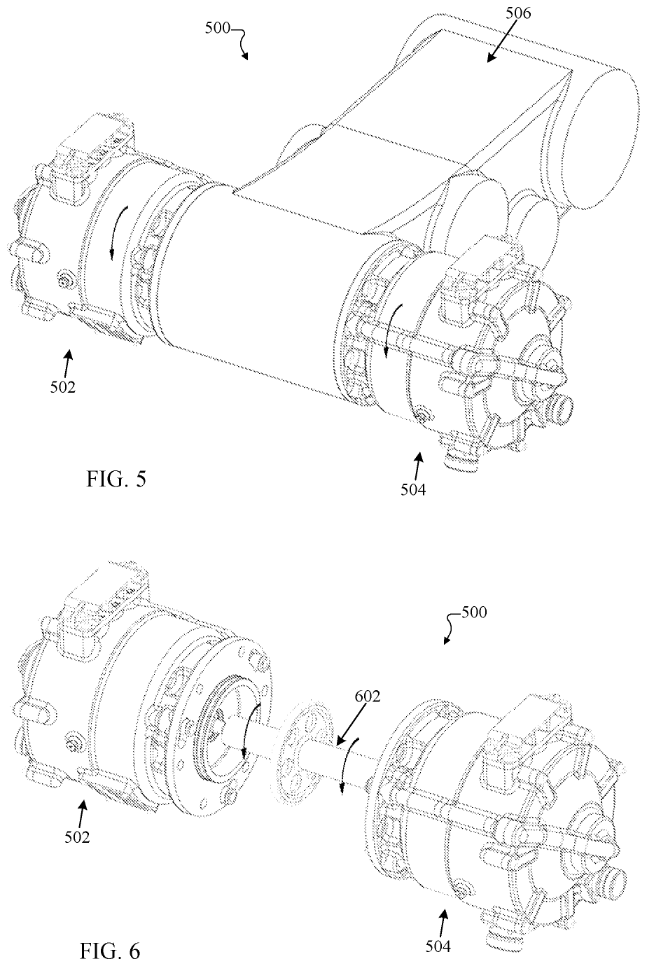

FIGS. 5 through 7 illustrate an example system 500 that incorporates multiple bidirectional to unidirectional gearsets 100 according to this disclosure. As shown in FIGS. 5 and 6, the system 500 includes a pair of generators 502 and 504 and an accessory gearbox 506. The accessory gearbox 506 represents a structure used with an aircraft engine to drive various accessories associated with an aircraft or the aircraft engine. In this example, the accessory gearbox 506 includes a rotatable shaft 602, which is used to drive the generators 502 and 504. In some embodiments, the generators 502 and 504 may represent turbomachines, such as electric generators with integral or coupled oil pumps. As a particular example, each of the generators 502 and 504 may include an oil pump connected to an electric generator.

As can be seen here, the shaft 602 may be designed to rotate in a single direction, which in this example is counterclockwise in the views shown in FIGS. 5 and 6. As a result, the shaft 602 (which represents an input shaft for each generator 502 and 504) has opposite rotational directions from the perspective of the generators 502 and 504. That is, while looking at the generator 502 from a point of view along the shaft 602, the shaft 602 is rotating counterclockwise with respect to the generator 502. While looking at the generator 504 from the same point of view along the shaft 602, the shaft 602 is rotating clockwise with respect to the generator 504.

As noted above, one approach to dealing with these opposite rotational directions may be to use separate distinct designs for the generators 502 and 504. However, this increases development and recurring costs and requires the use of distinct hardware. As a result, this approach could require maintaining different components in stock and could lead to mistaken installation of one generator in an unusable position.

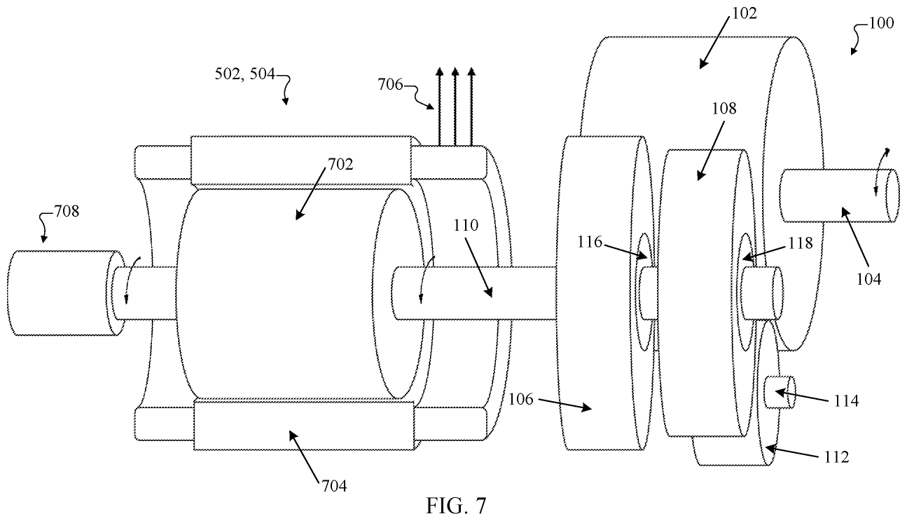

As shown in FIG. 7, each generator 502 and 504 can include or be coupled to an instance of the gearset 100, where the input shaft 104 represents or is coupled to the rotatable shaft 602. Each generator 502 and 504 in this example includes an electric generator that is formed using a rotor 702 and a stator 704. The output shaft 110 of the associated gearset 100 can cause the rotor 702 to rotate, which causes the stator 704 to generate electrical power 706. The output shaft 110 can also be coupled to and drive an oil pump 708. This arrangement can be replicated in both generators 502 and 504, which allows each generator 502 and 504 to drive its associated oil pump 708 in the same rotational direction, regardless of the generators 502 and 504 of the two input shafts 104 of the gearsets 100.

By incorporating an instance of the gearset 100 described above into each generator 502 and 504, the generators 502 and 504 can have a common design regardless of the direction of rotation of the shaft 602 relative to the generators 502 and 504. As a result, the gearsets 100 in the generators 502 and 504 allow a single design to be used, which can lower development and recurring costs since it enables common hardware to be used. This can also reduce potential installation mistakes since it is immaterial which device is installed on the left and right sides of the shaft 602. In other words, the generators 502 and 504 are interchangeable. In addition, when the generators 502 and 504 represent electric generators with integral or coupled oil pumps 708, it becomes possible to adjust the pump flows higher or lower for different rotational directions of the shaft 602 if needed or desired. As a particular example, if one generator 502 or 504 has higher losses or is otherwise less efficient compared to the other generator 504 or 502 due to the difference in input rotational direction, the gear ratios of the less efficient generator 502 or 504 can be tuned to rotate its oil pump 708 at a higher speed (in order to compensate for its lower efficiency and provide more cooling).

Although FIGS. 5 through 7 illustrate one example of a system 500 that incorporates multiple bidirectional to unidirectional gearsets 100, various changes may be made to FIGS. 5 through 7. For example, one or more instances of the bidirectional to unidirectional gearset 100 may be used with any other suitable mechanical device(s) and in any other suitable system(s).

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
a rotatable shaft having a first end and an opposing second end;
a first mechanical device configured to receive a first rotational input from the first end of the rotatable shaft; and
a second mechanical device configured to receive a second rotational input from the second end of the rotatable shaft, the second rotational input opposite the first rotational input;
wherein the first and second mechanical devices respectively comprise first and second gearsets, each of the gearsets comprising:
an input gear configured to be rotated by the rotatable shaft;
first and second one-way clutches;
first and second output gears configured to drive rotation of an output shaft via the first and second one-way clutches, respectively; and
an idler gear;
wherein the input gear of the first gearset is configured to (i) rotate the first output gear of the first gearset in a first direction and (ii) rotate the idler gear of the first gearset in the first direction, and wherein the idler gear of the first gearset is configured to rotate the second output gear of the first gearset in a second direction opposite the first direction;
wherein the input gear of the second gearset is configured to (i) rotate the first output gear of the second gearset in the second direction and (ii) rotate the idler gear of the second gearset in the second direction, and wherein the idler gear of the second gearset is configured to rotate the first output gear of the second gearset in the first direction; and
wherein the first and second one-way clutches of each gearset are configured to allow the first and second output gears of the gearset to drive rotation of the associated output shaft in a single predetermined rotational direction regardless of a rotational direction of the rotatable shaft relative to the gearset.

2. The system of claim 1, wherein:
the first and second mechanical devices comprise first and second generators; and
the rotatable shaft forms part of an aircraft accessory gearbox.

3. The system of claim 1, wherein each of the first and second mechanical devices comprises:
an electric generator; and
an oil pump coupled to or integral with the electric generator.

4. The system of claim 1, wherein:
the rotatable shaft is configured to rotate clockwise relative to the first mechanical device and counterclockwise relative to the second mechanical device; and
the first and second gearsets of the first and second mechanical devices are configured to cause rotation of both of the output shafts in the single predetermined rotational direction when the rotatable shaft is rotating clockwise and when the rotatable shaft is rotating counterclockwise.

5. The system of claim 1, wherein, in each of the first and second gearsets, the second output gear of the gearset has a smaller outer diameter than the first output gear of the gearset.

6. The system of claim 5, wherein, in each of the first and second gearsets, a portion of the idler gear of the gearset overlaps a portion of the first output gear of the gearset when the gearset is viewed from a direction parallel to an axis of the associated output shaft.

7. The system of claim 1, wherein:
the first one-way clutch of each gearset is configured to engage when the first output gear of the gearset is rotating in one of the first and second directions and disengage when the first output gear of the gearset is rotating in another of the first and second directions; and
the second one-way clutch of each gearset is configured to engage when the second output gear of the gearset is rotating in one of the first and second directions and disengage when the second output gear of the gearset is rotating in another of the first and second directions.

8. The system of claim 1, wherein the first and second mechanical devices are interchangeable.

9. An apparatus comprising:
a gearset comprising:
an input gear configured to be rotated by an input shaft;
first and second one-way clutches;
first and second output gears configured to drive rotation of an output shaft via the first and second one-way clutches, respectively, the second output gear having a smaller outer diameter than the first output gear; and
an idler gear;
wherein the input gear is configured to (i) rotate the first output gear in a first direction and (ii) rotate the idler gear in the first direction;
wherein the idler gear is configured to rotate the second output gear in a second direction opposite the first direction; and
wherein the first and second one-way clutches are configured to allow the first and second output gears to drive rotation of the output shaft in a single predetermined rotational direction regardless of a rotational direction of the input shaft.

10. The apparatus of claim 9, wherein:
the input shaft is configured to rotate clockwise or counterclockwise; and
the gearset is configured to cause rotation of the output shaft in the single predetermined rotational direction when the input shaft is rotating clockwise and when the input shaft is rotating counterclockwise.

11. The apparatus of claim 9, wherein a portion of the idler gear overlaps a portion of the first output gear when the gearset is viewed from a direction parallel to an axis of the output shaft.

12. The apparatus of claim 9, wherein:
the first one-way clutch is configured to engage when the first output gear is rotating in one of the first and second directions and disengage when the first output gear is rotating in another of the first and second directions; and
the second one-way clutch is configured to engage when the second output gear is rotating in one of the first and second directions and disengage when the second output gear is rotating in another of the first and second directions.

13. The apparatus of claim 9, wherein:
the gearset forms part of or is coupled to a generator; and
the generator is coupled to a rotatable shaft forming part of an aircraft accessory gearbox.

14. The apparatus of claim 13, wherein the gearset is configured to cause rotation of the output gear in the single predetermined rotational direction regardless of whether the generator receives a first rotational input from a first end of the rotatable shaft or a second rotational input from a second end of the rotatable shaft.

15. The apparatus of claim 9, wherein:
the gearset forms part of or is coupled to a generator;
the generator comprises:
an electric generator; and
an oil pump coupled to or integral with the electric generator; and
the output shaft is configured to drive the electric generator and the oil pump.

16. A method comprising:
imparting rotational input to an input gear of a gearset using an input shaft; and
driving rotation of an output shaft using first and second output gears of the gearset respectively via first and second one-way clutches and an idler gear of the gearset;
wherein the input gear (i) rotates the first output gear in a first direction and (ii) rotates the idler gear in the first direction;
wherein the idler gear rotates the second output gear in a second direction opposite the first direction;
wherein the first and second one-way clutches allow the first and second output gears to drive rotation of the output shaft in a single predetermined rotational direction regardless of a rotational direction of the input shaft; and
wherein the second output gear has a smaller outer diameter than the first output gear.

17. The method of claim 16, wherein:
the gearset represents a first gearset; and
the method further comprises:
imparting rotational input to an input gear of a second gearset, the rotational input to the input gear of the second gearset opposite the rotational input to the input gear of the first gearset; and
driving rotation of another output shaft using first and second output gears of the second gearset respectively via first and second one-way clutches and an idler gear of the second gearset.

18. The method of claim 16, wherein:
the gearset forms part of or is coupled to a generator; and
imparting the rotational input to the input gear comprises imparting the rotational input to the input gear based on rotation of a rotatable shaft forming part of an aircraft accessory gearbox.

19. The method of claim 18, wherein:
the generator comprises an electric generator and an oil pump coupled to or integral with the electric generator; and
the output shaft drives the electric generator and the oil pump.

20. The method of claim 16, wherein:
the input shaft is configured to rotate clockwise or counterclockwise; and
the gearset causes rotation of the output shaft in the single predetermined rotational direction when the input shaft is rotating clockwise and when the input shaft is rotating counterclockwise.
